(19) United States
(12) Patent Application Publication
(10) Pub. No.: US 2026/0058866 A1
(43) Pub. Date: Feb. 26, 2026

(54) COMMUNICATION MANAGEMENT DEVICE, COMMUNICATION MANAGEMENT METHOD, AND PROGRAM

(71) Applicant: NEC Corporation, Minato-ku, Tokyo (JP)

(72) Inventors: Yuji SATO, Tokyo (JP); Kazuki OGATA, Tokyo (JP); Jun TAKASAWA, Tokyo (JP); Takashi TONEGAWA, Tokyo (JP); Kosei KOBAYASHI, Tokyo (JP); Hideki KIKKAWA, Tokyo (JP)

(73) Assignee: NEC Corporation, Minato-ku, Tokyo (JP)

(21) Appl. No.: 19/104,716

(22) PCT Filed: Aug. 24, 2022
(86) PCT No.: PCT/JP2022/031888

§ 371 Date: Feb. 19, 2025

(51) Int. Cl. H04L 41/0677; G06T 7/00; G06T 7/20; G06V 10/82; G06V 20/40

(52) U.S. Cl. CPC H04L 41/0677; G06T 7/0002; G06T 7/20; G06T 2207/10016; G06T 2207/30236; G06V 10/82; G06V 20/41; G06V 2201/08

(57) ABSTRACT

In order to enable a cause of communication failure of communication equipment provided at an intersection to be avoided, a communication management apparatus (1) includes: obtaining means (12) that obtains traffic information on an intersection as a video; analysis means (13) that analyzes the video which has been obtained by the obtaining means (12); and control means (15) that causes, in a case where a cause of communication failure of the communication means (11) is recognized by the analysis means (13), driving means (14) to change a direction of the communication means (11) in accordance with the cause of the communication failure.

### TECHNICAL FIELD

The present invention relates to a communication management apparatus, a communication management method, and a program.

### BACKGROUND ART

Conventionally, communication apparatuses have been under development which detect obstacles and change directions of antennas having directivity so as to avoid the obstacles. As a technology related to this, an invention is disclosed in Patent Literature 1 below.

Patent Literature 1 discloses a communication apparatus including: an obstacle detection section that detects that a communication obstacle has entered the radio propagation path between a user's vehicle and the communication destination; an edge detection section that detects an edge of an outer edge shape of the communication obstacle in a case where the communication obstacle that has entered the radio propagation path is viewed from the user's vehicle; and a control section that, in a case where the communication obstacle has entered the radio propagation path, controls a radio communication section so as to change a direction of a directional beam of a directional antenna from a direction toward the communication destination to a direction toward the edge of the communication obstacle.

### CITATION LIST

### Patent Literature

### [Patent Literature 1]

Japanese Patent Application Publication, Tokukai, No. 2020-080066

### SUMMARY OF INVENTION

### Technical Problem

Conventionally, attempts have been made to provide communication equipment and cameras to traffic lights to sophisticate traffic control. However, communication conditions of the communication equipment may deteriorate depending on changes of the surrounding environment. Specifically, communication conditions may deteriorate due to, for example, trees growing between the antenna and the base station and obstacles such as trucks stopping in front of the antenna.

The communication apparatus disclosed in Patent Literature 1 detects that a communication obstacle has entered the radio propagation path between the user's vehicle and the communication destination and changes a direction of the directional beam of the directional antenna to a direction toward the edge of the communication obstacle. Therefore, it is a premise that the communication apparatus moves in accordance with the movement of the user's vehicle and a communication obstacle exists in front of the user's vehicle. Therefore, in a system in which communication equipment is installed at an intersection, it is impossible to apply the technology disclosed in Patent Literature 1 in a case where, for example, there is an obstacle between an antenna of the communication equipment and a base station.

An example aspect of the present invention has been implemented in light of the foregoing issue, and it is an example object thereof to provide a technology that makes it possible to avoid a cause of communication failure of communication equipment provided at an intersection.

### Solution to Problem

A communication management apparatus in accordance with one example aspect of the present invention includes: communication means that is communicable with a base station, that is provided at an intersection, and that has directivity; obtaining means that obtains traffic information on the intersection as a video; analysis means that analyzes the video which has been obtained by the obtaining means; driving means that changes a direction of the communication means; and control means that causes, in a case where a cause of communication failure of the communication means is recognized by the analysis means, the driving means to change the direction of the communication means in accordance with the cause of the communication failure.

A communication management method in accordance with one example aspect of the present invention includes: obtaining traffic information on an intersection as a video; analyzing the video which has been obtained; and changing, in a case where a cause of communication failure of communication means that is communicable with a base station, that is provided at the intersection, and that has directivity is recognized, a direction of the communication means in accordance with the cause of the communication failure.

A program in accordance with one example aspect of the present invention causes a computer to carry out: a process of obtaining traffic information on an intersection as a video; a process of analyzing the video which has been obtained; and a process of changing, in a case where a cause of communication failure of communication means that is communicable with a base station, that is provided at the intersection, and that has directivity is recognized, a direction of the communication means in accordance with the cause of the communication failure.

### Advantageous Effects of Invention

According to one example aspect of the present invention, it is possible to avoid a cause of communication failure of communication equipment provided at an intersection.

### BRIEF DESCRIPTION OF DRAWINGS

FIG. 1 is a block diagram illustrating a configuration example of a communication management apparatus in accordance with a first example embodiment of the present invention.

FIG. 2 is a flowchart illustrating the flow of a communication management method by the communication management apparatus in accordance with the first example embodiment of the present invention.

FIG. 3 is a view illustrating one example of an intersection in which a communication management apparatus in accordance with a second example embodiment of the present invention is provided.

FIG. 4 is a block diagram illustrating a configuration example of the communication management apparatus in accordance with the second example embodiment of the present invention.

FIG. 5 is a block diagram illustrating the configuration of a computer that functions as the communication management apparatus in accordance with each of the example embodiments.

### EXAMPLE EMBODIMENTS

### First Example Embodiment

<Communication Management Apparatus 1 in Accordance with First Example Embodiment>

The following description will discuss a first example embodiment of the present invention in detail with reference to the drawings. The present example embodiment is a basic form of an example embodiment described later. Note that reference signs which are indicated in the drawings and are used in this overview are given to elements for convenience as an example for assisting in understanding, and are not intended to limit the present invention to the illustrated aspects. The connection lines between blocks in the drawings and the like referred to in the descriptions below include both a bidirectional relation and a unidirectional relation. The one-way arrow schematically indicates a flow of a main signal (data), and does not exclude bidirectionality. The connection point of an input and an output of each of the blocks in the drawings may be configured to include a port or an interface. The configurations of these are not illustrated.

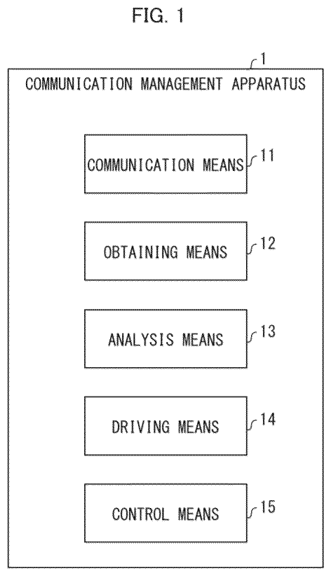

FIG. 1 is a block diagram illustrating a configuration example of a communication management apparatus 1 in accordance with the first example embodiment of the present invention. As illustrated in FIG. 1, the communication management apparatus 1 in accordance with the present example embodiment includes communication means 11, obtaining means 12, analysis means 13, driving means 14, and control means 15.

The communication means 11 is communicable with a base station, is provided at an intersection, and has directivity. The communication means 11 is, for example, an antenna having directivity. Communication failure may occur in the communication means 11 due to a plurality of causes, e.g., a case where the communication failure occurs due to an obstacle between the communication means 11 and the base station, a case where the communication failure occurs due to radio wave interference, and the like.

The base station is, for example, the next generation Node B (gNB) in the 5G (fifth-generation mobile communication system) core network (5GC) specified by the 3GPP (third-generation mobile communication system partnership project) or the evolved Node B (eNB) in the 4G (fourth-generation mobile communication system) core network (4GC).

The communication means 11, which is provided at, for example, a traffic light at an intersection, is installed in a position in which communication with the base station is not blocked by, for example, standard-sized vehicles or pedestrians. However, the communication with the base station may be blocked by a large-sized vehicle, such as a truck.

The obtaining means 12 obtains traffic information on an intersection as a video. For example, the obtaining means 12 may obtain a video shot with one or more cameras provided at an intersection. The one or more cameras may shot a video of the entirety of the intersection or may shot a video of only a part of the intersection.

The analysis means 13 analyzes the video obtained by the obtaining means 12. For example, the analysis means 13 may carry out object recognition by using deep learning such as a convolutional neural network (CNN), to identify an object in the video. For example, the analysis means 13 is configured to identify a vehicle and the model of the vehicle from the video. The analysis means 13 then determines whether or not the vehicle is a large-sized vehicle, from the model of the vehicle, and recognizes whether or not the vehicle is an object that can be a cause (obstacle) of communication failure. The analysis means 13 may be configured to recognize an object other than a vehicle, such as a tree or a building, that can be a cause (obstacle) of communication failure.

The driving means 14 changes a direction of communication means. The driving means 14, which is constituted by, for example, a servo motor, can change a direction of the communication means 11 in a vertical direction or a horizontal direction.

In a case where a cause of communication failure of the communication means 11 is recognized by the analysis means 13, the control means 15 causes the driving means 14 to change a direction of the communication means 11 in accordance with the cause of the communication failure. For example, in a case where an obstacle is recognized by the analysis means 13, the control means 15 causes the driving means 14 to change a direction of the communication means 11 so as to avoid a direction where the obstacle exists.

The communication means 11, the obtaining means 12, the analysis means 13, the driving means 14, and the control means 15 are, for example, configured to be communicable via a network. Although a specific configuration of the network is not intended to limit the present example embodiment, examples of the network may include a wireless local area network (LAN), a wired LAN, a wide area network (WAN), a public network, a mobile data communication network, and a combination of these networks.

The functions of the communication management apparatus 1 may be implemented in a cloud or on multi-access Edge Computing (MEC). For example, the communication means 11 and the driving means 14 may be a single apparatus, or the obtaining means 12, the analysis means 13, and the control means 15 may be a single apparatus. These may be implemented in a single apparatus or in separate apparatuses. For example, in a case where these functions are implemented in separate apparatuses, information of each section is transmitted and received via a network to proceed with the process.

### <Example Advantage of Communication Management Apparatus 1>

As described above, according to the communication management apparatus 1 in accordance with the present example embodiment, in a case where a cause of communication failure of the communication means 11 is recognized by the analysis means 13, the control means 15 causes the driving means 14 to change a direction of the communication means 11 in accordance with the cause of the communication failure. Therefore, the communication management apparatus 1 makes it possible to avoid a cause of communication failure of the communication means 11 provided at an intersection.

### <Flow of Communication Management Method S1 by Communication Management Apparatus 1>

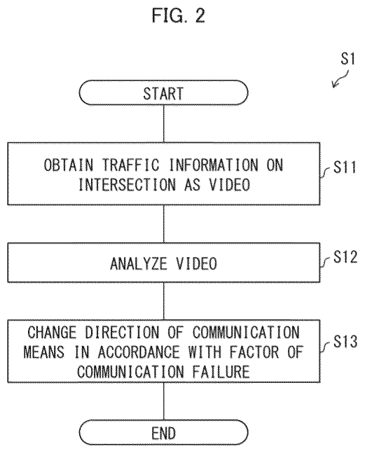

The following description will discuss the flow of a communication management method carried out by the communication management apparatus 1 configured as described in the foregoing, with reference to FIG. 2. FIG. 2 is a flowchart illustrating the flow of the communication management method. As illustrated in FIG. 2, the communication management method S1 includes steps S11 to S13.

First, the obtaining means 12 obtains (S11) traffic information on an intersection as a video. For example, the obtaining means 12 may obtain a video shot with one or more cameras provided at an intersection. The one or more cameras may shot a video of the entirety of the intersection or may shot a video of only a part of the intersection.

Subsequently, the analysis means 13 analyzes (S12) a video obtained. For example, the analysis means 13 is configured to identify a vehicle and the model of the vehicle from the video. The analysis means 13 then determines whether or not the vehicle is a large-sized vehicle, from the model of the vehicle, and recognizes whether or not the vehicle is an object that can be a cause (obstacle) of communication failure. The analysis means 13 may be configured to recognize an object other than a vehicle, such as a tree or a building, that can be a cause (obstacle) of communication failure.

Finally, in a case where a cause of communication failure of the communication means 11 that is communicable with a base station, that is provided at an intersection, and that has directivity is recognized by the analysis means 13, the control means 15 changes (S13) a direction of the communication means 11 in accordance with the cause of the communication failure. For example, in a case where an obstacle is recognized by the analysis means 13, the control means 15 causes the driving means 14 to change a direction of the communication means 11 so as to avoid a direction where the obstacle exists.

### <Example Advantage of Communication Management Method S1>

As described above, according to the communication management method S1 by the communication management apparatus 1 in accordance with the present example embodiment, in a case where a cause of communication failure of the communication means 11 is recognized by the analysis means 13, the control means 15 causes the driving means 14 to change a direction of the communication means 11 in accordance with the cause of the communication failure. Therefore, the communication management apparatus 1 makes it possible to avoid a cause of communication failure of the communication means 11 provided at an intersection.

### Second Example Embodiment

<Configuration Example of Communication Management Apparatus 1A in Accordance with Second Example Embodiment>

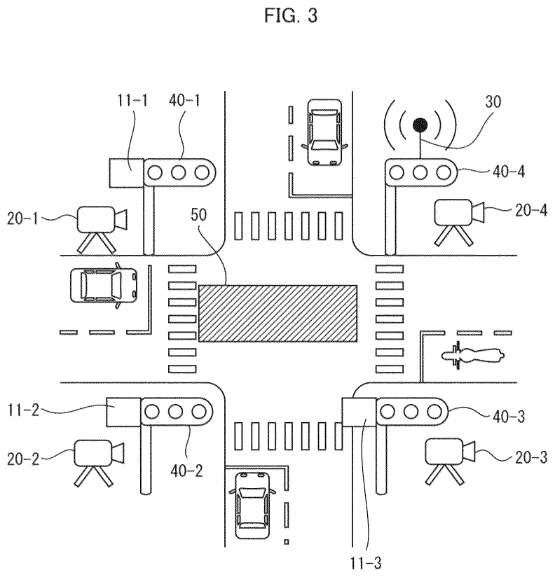

FIG. 3 is a view illustrating one example of an intersection in which a communication management apparatus 1A in accordance with a second example embodiment of the present invention is provided. As illustrated in FIG. 3, four traffic lights 40-1 to 40-4 are installed at the intersection. The traffic light 40-1 is provided with a communication section 11-1 (communication management apparatus) and a camera 20-1. The traffic light 40-2 is provided with a communication section 11-2 (communication management apparatus) and a camera 20-2. The traffic light 40-3 is provided with a communication section 11-3 (communication management apparatus) and a camera 20-3. The traffic light 40-4 is provided with a base station 30 and a camera 20-4.

For example, the communication management apparatus including the communication section 11-1 may obtain a video from the camera 20-1 to analyze the video showing only a part of the intersection, or alternatively, the communication management apparatus may obtain four videos from the respective cameras 20-1 to 20-4 to analyze the videos showing the entirety of the intersection.

In a case where as illustrated in FIG. 3, the communication management apparatus including the communication section 11-2 recognizes that there exists an obstacle 50 between the communication section 11-2 and the base station 30, the direction of the communication section 11-2 is changed so as to avoid a direction where the obstacle 50 exists.

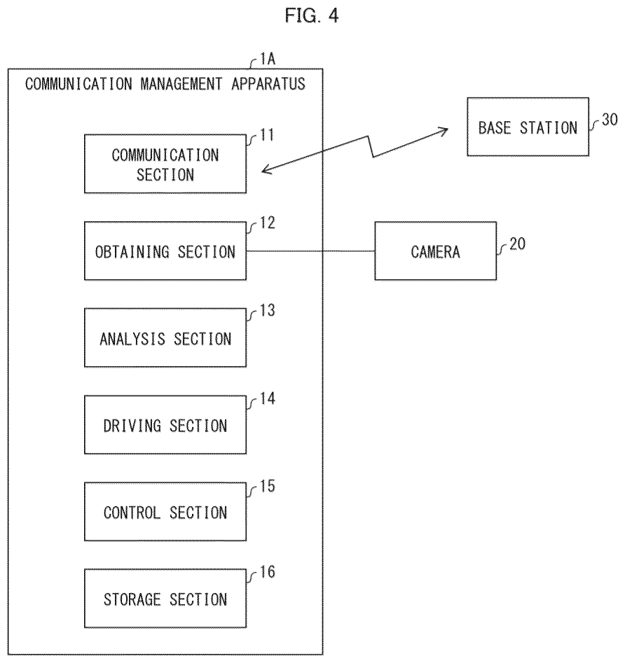

FIG. 4 is a block diagram illustrating a configuration example of the communication management apparatus 1A in accordance with a second example embodiment of the present invention. The communication management apparatus 1A includes the communication sections 11, an obtaining section 12, an analysis section 13, a driving section 14, a control section 15, and a storage section 16. The communication section 11 has a configuration for implementing communication means in the present example embodiment. The obtaining section 12 has a configuration for implementing obtaining means in the present example embodiment. The analysis section 13 has a configuration for implementing analysis means in the present example embodiment. The driving section 14 has a configuration for implementing driving means in the present example embodiment. The control section 15 has a configuration for implementing control means in the present example embodiment. The storage section 16 has a configuration for implementing storage means in the present example embodiment.

The communication sections 11 are each communicable with a base station 30, is provided at an intersection, and has directivity. The communication section 11 is, for example, an antenna having directivity. Communication failure may occur in the communication section 11 due to a plurality of causes, e.g., a case where the communication failure occurs due to an obstacle between the communication section 11 and the base station 30 and a case where the communication failure occurs due to radio wave interference.

The obtaining section 12 obtains traffic information on an intersection as a video from the cameras 20 provided at the intersection. For example, the obtaining section 12 may obtain videos shot with one or more cameras 20-1 to 20-4 provided at the intersection, as illustrated in FIG. 3.

The analysis section 13 analyzes the video obtained by the obtaining section 12. For example, the analysis section 13 is configured to identify a vehicle and the model of the vehicle from the video. The analysis section 13 then determines whether or not the vehicle is a large-sized vehicle, from the model of the vehicle, and recognizes whether or not the vehicle is an object that can be a cause of communication failure (an obstacle that inhibits communication by the communication section 11).

Note that the analysis section 13 may not identify the model of the vehicle and may analyze whether or not the vehicle stops while blocking the wireless communication path. In a case where the analysis section 13 determines whether or not the vehicle is a large-sized vehicle, the analysis section 13 may determine whether or not the vehicle is a large-sized vehicle, from the size of the vehicle in the image rather than from the model of the vehicle.

The driving section 14 changes a direction of the communication section 11. The driving section 14, which is constituted by, for example, a servo motor, can change a direction of the communication section 11 in a vertical direction or a horizontal direction.

In a case where a cause of communication failure of the communication section 11 is recognized by the analysis section 13, the control section 15 causes the driving section 14 to change a direction of the communication section 11 in accordance with the cause of the communication failure. For example, in a case where an obstacle is recognized by the analysis section 13, the control section 15 causes the driving section 14 to change a direction of the communication section 11 so as to avoid a direction where the obstacle exists.

The analysis section 13 perform prediction of movement of an obstacle. For example, the analysis section 13 identifies the movement direction of the large-sized vehicle, from the video (images including multiple frames) that has been obtained from the cameras 20. The analysis section 13 predicts whether or not the large-sized vehicle can be an obstacle in the future depending on the movement direction thereof, even in a case where the large-sized vehicle is not currently an obstacle.

The control section 15 causes the driving section 14 to change a direction of the communication section 11 in accordance with the prediction of movement of an obstacle. For example, in a case where the analysis section 13 predicts that the large-sized vehicle can be an obstacle, the control section 15 causes the driving section 14 to change a direction of the communication section 11 in advance.

The storage section 16 stores past videos of the intersection. The past videos of the intersection may be, for example, of the intersection during a period in which communication quality deteriorated or may be of the intersection during a period in which communication quality was favorable.

The analysis section 13 analyzes a cause of communication failure of the communication section 11 by comparing a past video of the intersection and a video of the intersection which has been obtained by the obtaining section 12. For example, in a case where the past video of the intersection is of the intersection during a period in which communication quality deteriorated, the analysis section 13 carries out a matching process between the past video of the intersection and a video of the intersection which has been obtained by the obtaining section 12. In a case where a degree of similarity therebetween is equal to or more than a predetermined value, the analysis section 13 identifies the cause of the communication failure of the communication section 11.

The storage section 16 stores a plurality of past videos of the intersection during a period in which communication quality deteriorated and stores a cause of communication failure and a direction of the communication section 11 for avoiding the communication failure, the cause and the direction corresponding to each of the videos. The analysis section 13 carries out a matching process between a past video of the intersection which has been obtained during a period in which communication quality deteriorated and which is stored in the storage section 16 and a current video of the intersection which has been obtained by the obtaining section 12. In a case where there exists a past video having a degree of similarity equal to or greater than a predetermined value, the analysis section 13 identifies, as the cause of the current communication failure, a cause of communication failure corresponding the past video.

The control section 15 obtains a direction of the communication section 11 for avoiding the communication failure and causes the driving section 14 to change a direction of the communication section 11. Note that the past video may be a past video of an intersection immediately before communication quality deteriorates.

As such, in a case where the current video of the intersection resembles a past video of the intersection during a period in which communication quality deteriorated, the analysis section 13 determines that an event that can be a cause of the communication failure is occurring. For example, in a case where the past video of the intersection during a period in which communication quality deteriorated is a video which had been obtained while a truck was entering a position in which the communication is disrupted, the analysis section 13 detects that the current condition of the intersection resembles that condition, and can predict that a truck likely enters a position in which the communication is disrupted.

In a case where the past video of the intersection during a period in which communication quality deteriorated is a video showing communication failure caused by, for example, interference of radio waves, the analysis section 13 can detect that the current condition of the intersection resembles that condition, and predict that communication failure likely occurs due to a cause other than an obstacle.

The control section 15 causes the driving section 14 to change a direction of the communication section 11 in accordance with the cause of the communication failure. As such, the communication management apparatus 1A can, before communication quality deteriorates, predict a cause of communication failure and change a direction of the communication section 11.

In a case where the past video of the intersection is of the intersection during a period in which communication quality was favorable, the analysis section 13 identifies a cause of the communication failure by comparing a video of the intersection during a period in which communication quality was favorable and the video of the intersection which has been obtained by the obtaining section 12 during a period in which communication quality deteriorated.

For example, in a case where there is a difference between the past video of the intersection during a period in which communication quality was favorable and a video of the intersection which has been obtained by the obtaining section 12 during a period in which communication quality deteriorated, the analysis section 13 can identify, as the cause of the communication failure, a part having the difference in the video which has been obtained by the obtaining section 12.

In a case where no cause of communication failure of the communication section 11 is identified by the analysis section 13, the control section 15 does not cause the driving section 14 to change a direction of the communication section 11. For example, in a case where the analysis section 13 cannot identify a cause of the communication failure even by comparing a past video of the intersection during a period in which communication quality was favorable and the video of the intersection which has been obtained by the obtaining section 12 during a period in which communication quality deteriorated, the analysis section 13 can determine that deterioration in the communication quality is caused not by an object in the intersection but by, for example, network failure. In the case of network failure, there is no need to change a direction of the communication section 11, and thus the control section 15 does not cause the driving section 14 to change a direction of the communication section 11.

### <Example Advantage of Communication Management Apparatus 1A>

As described above, according to the communication management apparatus 1A in accordance with the present example embodiment, the analysis section 13 perform prediction of movement of an obstacle, and the control section 15 causes the driving section 14 to change a direction of the communication section 11 in accordance with the prediction of the movement of the obstacle. Therefore, the control section 15 can change a direction of the communication section 11 before an obstacle disrupts the communication.

The analysis section 13 analyzes a cause of communication failure of the communication section 11 by comparing a past video of an intersection and a video of the intersection which has been obtained by the obtaining section 12. Therefore, there is no need for the analysis section 13 to carry out object recognition, thereby making it possible to reduce processing load.

The analysis section 13 carries out a matching process between a past video of the intersection during a period in which communication quality deteriorated and a video of the intersection which has been obtained by the obtaining section 12, and in a case where a degree of similarity therebetween is equal to or more than a predetermined value, the analysis section 13 identifies a cause of the communication failure of the communication section 11. Therefore, in a case where the current video of the intersection resembles a past video of the intersection during a period in which communication quality deteriorated, the analysis section 13 can determine that an event that can be a cause of the communication failure is occurring.

In a case where the past video of the intersection during a period in which communication quality deteriorated is a video showing communication failure caused by, for example, interference of radio waves, the analysis section 13 can detect that the current condition of the intersection resembles that condition, and predict that communication failure likely occurs due to a cause other than an obstacle.

The analysis section 13 identify a cause of the communication failure by comparing a past video of the intersection during a period in which communication quality was favorable and a video of the intersection which has been obtained by the obtaining section 12 during a period in which communication quality deteriorated. Therefore, the analysis section 13 can identify, as a cause of communication failure, a part having a difference in the video.

In a case where no cause of communication failure of the communication section 11 is identified by the analysis section 13, the control section 15 does not cause the driving section 14 to change a direction of the communication section 11. Therefore, in a case where it can be determined that deterioration in communication quality is caused not by an object in the intersection but by, for example, network failure, it is possible to eliminate the need to change a direction of the communication section 11.

### Software Implementation Example

Some or all of the functions of each of the communication management apparatuses 1 and 1A may be implemented by hardware such as an integrated circuit (IC chip), or may be alternatively implemented by software.

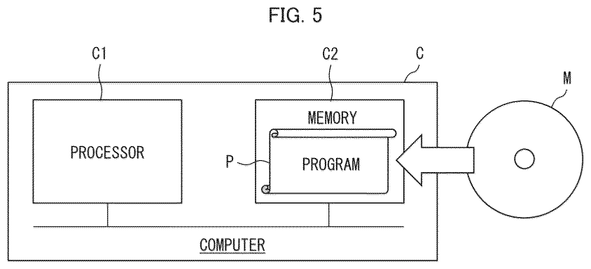

In the latter case, each of the communication management apparatuses 1 and 1A is implemented by, for example, a computer that executes instructions of a program that is software implementing the foregoing functions. FIG. 5 illustrates an example of such a computer (hereinafter, referred to as “computer C”). The computer C includes at least one processor C1 and at least one memory C2. The memory C2 stores a program P for causing the computer C to operate as each of the communication management apparatuses 1 and 1A. The processor C1 of the computer C retrieves the program P from the memory C2 and executes the program P, so that the functions of each of the communication management apparatuses 1 and 1A are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C may further include a RAM in which the program P is loaded in execution of the program P and/or in which various kinds of data are temporarily stored. The computer C may further include a communication interface via which data is transmitted to and received from another apparatus. The computer C may further include an input/output interface for connecting input/output apparatuses such as a keyboard, a mouse, a display, and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### Supplementary Note 1

A communication management apparatus including:
communication means that is communicable with a base station, that is provided at an intersection, and that has directivity;
obtaining means that obtains traffic information on the intersection as a video;
analysis means that analyzes the video which has been obtained by the obtaining means;
driving means that changes a direction of the communication means; and
control means that causes, in a case where a cause of communication failure of the communication means is recognized by the analysis means, the driving means to change the direction of the communication means in accordance with the cause of the communication failure.

The above configuration makes it possible to avoid a cause of communication failure of the communication means provided at an intersection.

### Supplementary Note 2

The communication management apparatus according to supplementary note 1, wherein the cause of the communication failure is an obstacle that disrupts communication of the communication means.

### Supplementary Note 3

The communication management apparatus according to supplementary note 2, wherein:
the analysis means performs prediction of movement of the obstacle; and
the control means causes the driving means to change the direction of the communication means in accordance with the prediction of the movement of the obstacle.

According to the above configuration, the control means makes it possible to change a direction of the communication means before an obstacle disrupts the communication.

### Supplementary Note 4

The communication management apparatus according to supplementary note 1, further including storage means that stores a past video of the intersection,
the analysis means analyzing the cause of the communication failure of the communication means by comparing the past video of the intersection and the video of the intersection which has been obtained by the obtaining means.

According to the above configuration, there is no need for the analysis means to carry out object recognition, thereby making it possible to reduce processing load.

### Supplementary Note 5

The communication management apparatus according to supplementary note 4, wherein:
the past video of the intersection is of the intersection during a period in which communication quality deteriorated;
in a case where a degree of similarity between the past video of the intersection and the video of the intersection which has been obtained by the obtaining means is equal to or more than a predetermined value, the analysis means identifies the cause of the communication failure of the communication means; and
the control means causes the driving means to change the direction of the communication means in accordance with the cause of the communication failure.

Therefore, according to the above configuration, in a case where the current video of the intersection resembles a past video of the intersection during a period in which communication quality deteriorated, the analysis means can determine that an event that can be a cause of the communication failure is occurring. Further, the analysis means can predict that communication failure likely occurs due to a cause other than an obstacle.

### Supplementary Note 6

The communication management apparatus according to supplementary note 4, wherein:
the past video of the intersection is of the intersection during a period in which communication quality was favorable; and
the analysis means identifies the cause of the communication failure by comparing the video of the intersection during the period in which the communication quality was favorable and a video of the intersection that has been obtained by the obtaining means during a period in which the communication quality deteriorated.

According to the above configuration, the analysis means can identify, as a cause of communication failure, a part having a difference in the video.

### Supplementary Note 7

The communication management apparatus according supplementary note 6, wherein in a case where no cause of the communication failure of the communication means is identified by the analysis means, the control means does not cause the driving means to change the direction of the communication means.

According to the above configuration, in a case where it can be determined that deterioration in communication quality is caused not by an object in the intersection but by, for example, network failure, it is possible to eliminate the need to change a direction of the communication means.

### Supplementary Note 8

A communication management method including:
obtaining traffic information on an intersection as a video;
analyzing the video which has been obtained; and
changing, in a case where a cause of communication failure of communication means that is communicable with a base station, that is provided at the intersection, and that has directivity is recognized, a direction of the communication means in accordance with the cause of the communication failure.

The above configuration makes it possible to avoid a cause of communication failure of the communication means provided at an intersection.

### Supplementary Note 9

A program for causing a computer to carry out:
a process of obtaining traffic information on an intersection as a video;
a process of analyzing the video which has been obtained; and
a process of changing, in a case where a cause of communication failure of communication means that is communicable with a base station, that is provided at the intersection, and that has directivity is recognized, a direction of the communication means in accordance with the cause of the communication failure.

The above configuration makes it possible to avoid a cause of communication failure of the communication means provided at an intersection.

### Supplementary Note 10

A communication management apparatus including at least one processor, the at least one processor carrying out:
a process of obtaining traffic information on an intersection as a video;
a process of analyzing the video which has been obtained; and
a process of changing, in a case where a cause of communication failure of communication means that is communicable with a base station, that is provided at the intersection, and that has directivity is recognized, a direction of the communication means in accordance with the cause of the communication failure.

It should be noted that this communication management apparatus may further include a memory, which may store therein a program for causing the at least one processor to carry out the obtaining process, the analysis process, and the changing process. Alternatively, the program may be stored in a computer-readable, non-transitory, tangible storage medium.

### REFERENCE SIGNS LIST

1, 1A Communication management apparatus
11 Communication section (communication means)
12 Obtaining section (obtaining means)
13 Analysis section (analysis means)
14 Driving section (driving means)
15 Control section (control means)
16 Storage section
20 Camera
30 Base station
40 Traffic light
50 Obstacle

What is claimed is:

1. A communication management apparatus comprising at least one processor, the at least one processor carrying out:
a process of obtaining traffic information on an intersection as a video;
a process of analyzing the video which has been obtained;
a process of changing a direction of a communication section that is communicable with a base station, that is provided at the intersection, and that has directivity; and
a process of changing, in a case where a cause of communication failure of the communication section is recognized, the direction of the communication section in accordance with the cause of the communication failure.

2. The communication management apparatus according to claim 1, wherein the cause of the communication failure is an obstacle that disrupts communication of the communication section.

3. The communication management apparatus according to claim 2, wherein:
the at least one processor performs prediction of movement of the obstacle in the process of analyzing; and
in the process of changing the direction of the communication section in accordance with the cause of the communication failure, the at least one processor changes the direction of the communication section in accordance with the prediction of the movement of the obstacle.

4. The communication management apparatus according to claim 1, wherein:
the at least one processor carries out a process of storing a past video of the intersection,
in the process of analyzing, the at least one processor analyzes the cause of the communication failure of the communication section by comparing the past video of the intersection and the video of the intersection which has been obtained.

5. The communication management apparatus according to claim 4, wherein:
the past video of the intersection is of the intersection during a period in which communication quality deteriorated; and
in the process of analyzing, in a case where a degree of similarity between the past video of the intersection and the video of the intersection which has been obtained is equal to or more than a predetermined value, the at least one processor identifies the cause of the communication failure of the communication section.

6. The communication management apparatus according to claim 4, wherein:
the past video of the intersection is of the intersection during a period in which communication quality was favorable; and
in the process of analyzing, the at least one processor means identifies the cause of the communication failure by comparing the video of the intersection during the period in which the communication quality was favorable and a video of the intersection during a period in which the communication quality deteriorated.

7. The communication management apparatus according to claim 6, wherein in a case where no cause of the communication failure of the communication section is identified, the at least one processor does not change the direction of the communication section in the process of changing the direction of the communication section in accordance with the cause of the communication failure.

8. A communication management method comprising:
obtaining traffic information on an intersection as a video;
analyzing the video which has been obtained; and
changing, in a case where a cause of communication failure of a communication section that is communicable with a base station, that is provided at the intersection, and that has directivity is recognized, a direction of the communication section in accordance with the cause of the communication failure.

9. (canceled)

10. The communication management method according to claim 8, wherein the cause of the communication failure is an obstacle that disrupts communication of the communication section.

11. The communication management method according to claim 10, wherein:
prediction of movement of the obstacle is performed in the analyzing; and
in the changing of the direction of the communication section in accordance with the cause of the communication failure, the direction of the communication section is changed in accordance with the prediction of the movement of the obstacle.

12. The communication management method according to claim 8, wherein:
a past video of the intersection is stored; and
in the analyzing, the cause of the communication failure of the communication section is analyzed by comparing the past video of the intersection and the video of the intersection which has been obtained.

13. The communication management method according to claim 12, wherein:
the past video of the intersection is of the intersection during a period in which communication quality deteriorated; and
in the analyzing, in a case where a degree of similarity between the past video of the intersection and the video of the intersection which has been obtained is equal to or more than a predetermined value, the cause of the communication failure of the communication section is identified.

14. The communication management method according to claim 12, wherein:
the past video of the intersection is of the intersection during a period in which communication quality was favorable; and
in the analyzing, the cause of the communication failure is identified by comparing the video of the intersection during the period in which the communication quality was favorable and a video of the intersection during a period in which the communication quality deteriorated.

15. The communication management method according to claim 14, wherein in a case where no cause of the communication failure of the communication section is identified, the direction of the communication section is not changed in the changing of the direction of the communication section in accordance with the cause of the communication failure.

16. A non-transitory storage medium storing a program for causing a computer to carry out:
a process of obtaining traffic information on an intersection as a video;
a process of analyzing the video which has been obtained; and
a process of changing, in a case where a cause of communication failure of a communication section that is communicable with a base station, that is provided at the intersection, and that has directivity is recognized, a direction of the communication section in accordance with the cause of the communication failure.

17. The non-transitory storage medium according to claim 16, wherein the cause of the communication failure is an obstacle that disrupts communication of the communication section.

18. The non-transitory storage medium according to claim 17, wherein:
the computer preforms prediction of movement of the obstacle in the process of analyzing; and
in the process of changing the direction of the communication section in accordance with the cause of the communication failure, the computer changes the direction of the communication section in accordance with the prediction of the movement of the obstacle.

19. The non-transitory storage medium according to claim 16, wherein:
the computer carries out a process of storing a past video of the intersection; and
in the process of analyzing, the computer analyzes the cause of the communication failure of the communication section by comparing the past video of the intersection and the video of the intersection which has been obtained.

20. The non-transitory storage medium according to claim 19, wherein:
the past video of the intersection is of the intersection during a period in which communication quality deteriorated; and
in the process of analyzing, in a case where a degree of similarity between the past video of the intersection and the video of the intersection which has been obtained is equal to or more than a predetermined value, the computer identifies the cause of the communication failure of the communication section.

21. The non-transitory storage medium according to claim 19, wherein:
the past video of the intersection is of the intersection during a period in which communication quality was favorable; and
in the process of analyzing, the computer identifies the cause of the communication failure by comparing the video of the intersection during the period in which the communication quality was favorable and a video of the intersection during a period in which the communication quality deteriorated.
